(19) United States
(12) Patent Application Publication
(10) Pub. No.: US 2008/0034216 A1
(43) Pub. Date: Feb. 7, 2008

(54) Mutual authentication and secure channel establishment between two parties using consecutive one-time passwords

(76) Inventor: Eric Chun Wah Law, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/499,541

(22) Filed: Aug. 3, 2006

(51) Int. Cl. H04L 9/00; H04K 1/00

(52) U.S. Cl. 713/183; 713/184; 713/168; 713/171

(57) ABSTRACT

A communication system and method are configured for mutual authentication and secure channel establishment between two parties. In one embodiment a first party generates a first one-time password and sends it to a second party. The second party authenticates the first party by generating a one-time password using the same algorithm, secrets and parameters and matching it with the received first one-time password. If the received first one-time password matches with a generated password, the second party generates a consecutive one-time password, and establishes a secure channel to the first party using the consecutive one-time password. The first party generates a consecutive one-time password and authenticates the second party by successfully communicating with the second party using the secure channel.

### CROSS REFERENCE TO RELATED APPLICATIONS

The present invention is related to U.S. patent application Ser. No. 11/377,866, entitled “Mutual Authentication Between Two Parties Using Two Consecutive One-Time Passwords,” by Eric Chun Wah Law, filed on Mar. 15, 2006, which is hereby incorporated by reference in its entirety.

### BACKGROUND

1. Field of Art

The present invention generally relates to the field of electronic communications, and more specifically, to mutual authentication and secure channel establishment for parties of electronic communications.

2. Description of the Related Art

The Internet has demonstrated exponential growth in the last 10 years. Today, hundreds of millions of users are relying on the Internet to communicate, to work and to do business. Unfortunately, the current means to identify individuals and businesses and to protect communication and business transactions are primitive and piece-meal. Everyday a massive volume of personal communications and online transactions such as online conference and online trading are conducted over the Internet without adequate authentication of the participating parties. Improper authentication of Internet users by businesses gives hackers the opportunity to access unauthorized information and to conduct fraudulent transactions, leading to monetary and proprietary damages. Improper authentication of business servers by users expose people to increasingly sophisticated online scams such as phishing and pharming. Improperly protected communication between Internet users and business servers exposes the content of the communication to potential hackers, compromising the users' privacy and the business's confidential information. Without appropriate authentication and confidentiality solutions, more and more Internet businesses and users are becoming victims of fraudulent transactions and identity theft.

The most common, and simplest, form of authentication is URL (Uniform Resource Locator)-password authentication. Typically, a first party verifies the identity of a second party by checking the second party's official URL, and the second party verifies the identity of the first party by checking the password provided by the first party. For example, when a user accesses his/her web-based email account, the user enters the URL of the web site providing the email service and visually verifies the connected or the re-directed URL shown by the browser. If the URL is accurate, the user submits his/her user identifier (ID) and password. The web site will then verify the user's ID and password.

The shortcoming of this method is that an accurate URL alone is not sufficient for server authentication. In a pharming scam, hackers could abuse the local domain name server to redirect a user to a malicious web site, even though the web address is legitimate. Further, the password is usually not encrypted while transferring over the Internet to the other party and it is therefore subject to malicious monitoring any where along the communications route. Moreover, the password is usually static, which could be hacked easily using viruses, spy-wares, proxies and network analyzers.

A slightly more sophisticated authentication method is authentication based on URL and one-time password. Similarly, a first party verifies the identity of a second party by checking the second party's official URL. Instead of a static password, the second party verifies the identity of the first party by checking a one-time password provided by the first party. A one-time password is a password that can only be used once such that it is computationally infeasible for an unauthorized third party to predict the next password when the current one is compromised.

This basic one-time password approach only addresses the client authentication side. It is useless for a malicious third party to steal a used one-time password because the one-time password has already expired after a single use. However, this basic one-time password approach shares the shortcoming of the URL-password scheme because the user is still unable to directly authenticate the server.

Alternatively, some server authentication schemes require a user to provide or select certain identification information when the user first registers for service. The additional identification information may include the user's personal data such as birthday, mother's maiden name, favorite pet's name or a picture of the user's choice. When the user signs in, the server will play back such information to the user for verification. If such information matches with what the user has provided earlier, the user considers the server as genuine. This additional server authentication mechanism is inadequate because such static identification information could be easily exposed to the sophisticated hackers, and subject users to fraudulent transactions and identity thefts.

A conventional method to protect communications between parties over a network is to establish a secure channel through which the parties can confidentially communicate with each other. Through a secure channel data can be transferred from one place to another without risk of interception or tampering. Secure channels are generally established using cryptographic algorithms such as encryption and decryption. However, cryptographic algorithms work when parties share the same or cryptographically related key (for symmetric and asymmetric cryptography respectively). Therefore, good security relies not only on strong cryptographic algorithms but also on how shared secrets or keys are handled.

Currently, both parties must be pre-configured with a shared key or cryptographically related keys before a secure channel may be established between them. The keys may be distributed to the parties using conventional communication methods (e.g., through email, facsimile or smart card). However, these conventional communication methods are themselves vulnerable. For example, emails and phone calls are subject to unauthorized interception and monitoring. Such vulnerability renders the secure channel insecure.

Therefore, there is a need for a secured system and process to ensure mutual authentication and secure channel establishment between both parties of an electronic communication.

### SUMMARY

The present invention provides a system and method for establishing mutual authentication and a secure channel between two parties using consecutive one-time passwords. Both parties share a predefined one-time password cryptographic algorithm, token secrets, and synchronized parameters including a monotonically increasing or decreasing sequence number.

In one embodiment, a first party generates a one-time password using the algorithm, token secrets and parameters, and sends it to a second party over a network. The second party verifies the received one-time password using the same algorithm, token secrets and parameters. Upon successful verification, the second party generates a consecutive one-time password, creates a session key (or a set of session keys) using the consecutive one-time password as an input and establishes a secure channel with the first party using the session key (or set of session keys). Similarly, the first party generates a consecutive one-time password, derives a session key from the consecutive one-time password, and communicates with the second party through the secure channel established based on the session key. The secure channel may be established using a single symmetric session key. Alternatively, the secure channel also may be established using multiple session keys. For example, one session key for encrypting data to the other party and another session key for decrypting data.

In another embodiment, after the secure channel is established, the two parties may verify the validity of the secure channel by encrypting known secrets, exchanging the encrypted known secrets, and verifying the known secrets and proper encryption by decrypting the received encrypted known secrets.

In still another embodiment, a challenge-response mechanism is employed to authenticate the two parties and to verify the validity of the newly established secure channel. The first party encrypts a random challenge code with the session key and sends it to the second party. The second party decrypts the received encrypted challenge code with the session key, derives a response code from the random challenge code, encrypts the response code with the session key, and echoes back to the first party with the encrypted response code. The first party will then decrypt it to verify the validity of the secure channel and the authenticity of the second party. Similarly, the second party can perform a challenge-response to verify the validity of the secure channel and to authenticate the first party.

The method of mutual authentication and secure channel establishment using consecutive one-time passwords has the following advantages. It ensures a secure two-way authentication by requiring both the user system and the server to compute (or derive) a consecutive one-time password from a communicated one-time password. In addition, it requires both the user system and the server to communicate using a secure channel established between the user system and the server using the derived one-time password as an input to create a session key (or a set of session keys for encryption, decryption, message signing and signature verification purposes) for the secure channel. The one-time passwords used in the process expire after a single use.

Data transmitted through the secure channel established in accordance with a system (and method) as disclosed is free from interception and tampering because the consecutive one-time password used to establish the secure channel is generated in the user system and the server. Therefore, the consecutive one-time password and the computed session key are never sent over the communication network between the two parties. By not pre-configuring the secure channel for transmitting security information using vulnerable conventional communication methods, a more secure and robust configuration is presented. The method is easy to implement since both parties share the same set of algorithm, token secrets and parameters, and mutual authentication and secure channels are established by communicating a single one-time password.

These features are not the only features of the invention. In view of the drawings, specification, and claims, many additional features and advantages will be apparent.

### BRIEF DESCRIPTION OF THE DRAWINGS

The disclosed embodiments have other advantages and features which will be more readily apparent from the following detailed description and the appended claims, when taken in conjunction with the accompanying drawings, in which:

Figure (FIG.) 1 illustrates one embodiment of a mutual authentication and secure channel establishment framework in accordance with the present invention.

FIG. 2 illustrates one embodiment of a one-time password token used to compute and display one-time password and secure channel in accordance with the present invention.

FIG. 3 illustrates one embodiment of a process for establishing mutual authentication and a secure channel between two parties in accordance with the present invention.

FIG. 4 illustrates one embodiment of a process to create a one-time password in accordance with the present invention.

### DETAILED DESCRIPTION

The Figures (FIGs.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

The description herein provides a system and a method for establishing mutual authentication and a secure channel between two parties using consecutive one-time passwords. For ease of understanding, the description made is in the context of electronic communication between a user and a computing server. However, the principles described herein are equally applicable for any transaction between parties, e.g., a buyer and a seller or a login requester and secured web site operator, and other applications between parties as noted above.

### Mutual Authentication and Secure Channel Establishment System

FIG. 1 illustrates one embodiment of a mutual authentication and secure channel establishment system 100 in accordance with the present invention. The system 100 includes a first party 110 and a second party 120. The first party 110 and the second party 120 are communicatively coupled through a network 130.

In one embodiment, the first party 110 may comprise a terminal 112 and a token 114. The terminal 112 is a computing device equipped and configured to communicate with the second party 120 through the network 130. Examples of the terminal 112 include a personal computer, a laptop computer, or a personal digital assistant (PDA) with a wired or wireless network interface and access or a smartphone or a mobile phone with wireless or cellular access. The token 114 is a security mechanism that provides a one-time password. The token 114 may be a standalone separate physical device or may be an application or applet running on the terminal 112 or a separate standalone physical device (e.g., a mobile phone or personal digital assistant).

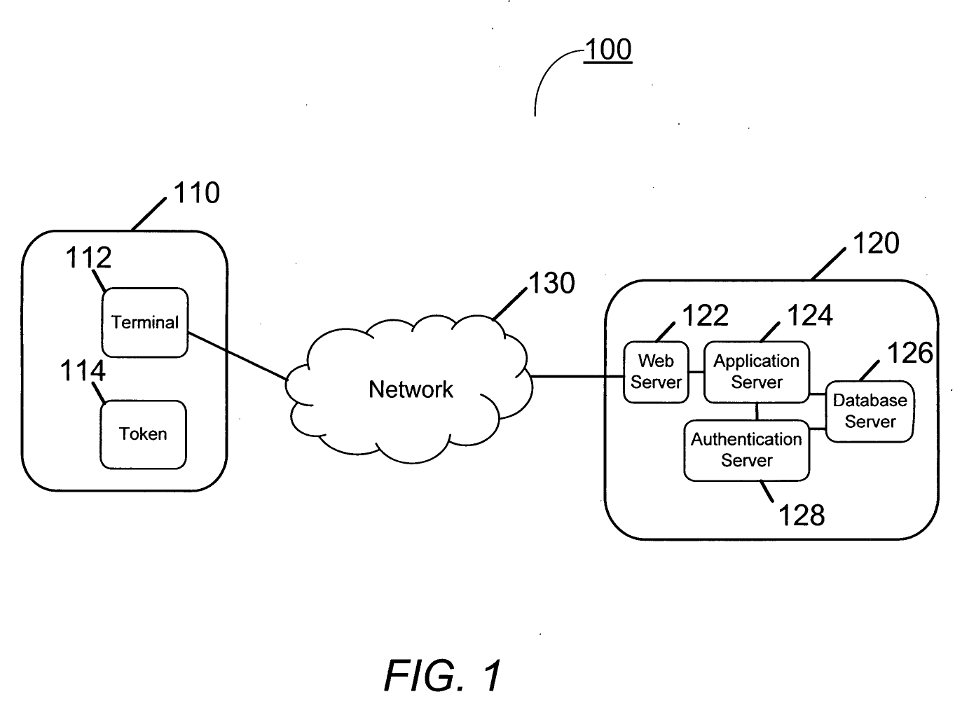

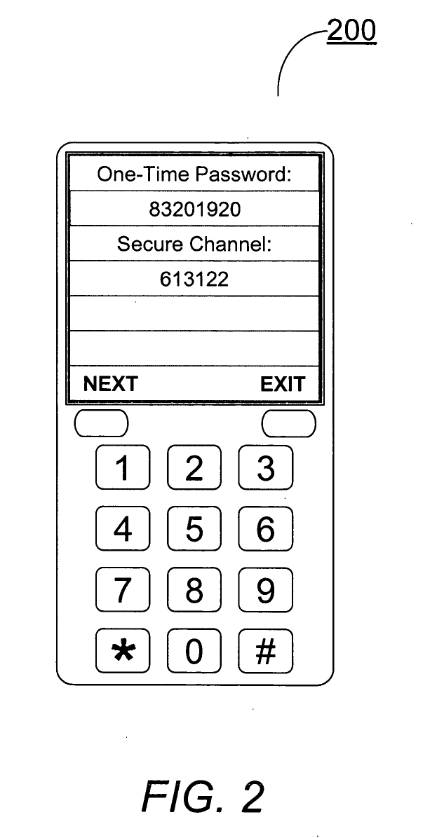

FIG. 2 illustrates one embodiment of the token 114 in accordance with the present invention. In FIG. 2, the token 114 is an application running on a mobile phone 200. The token 114 has a user interface displaying the provided one-time password. The one-time password displayed in the user interface is 83201920. The user interface can also display other relevant information, such as a consecutive one-time password as is further described herein. The consecutive one-time password is displayed in FIG. 2 as a secure channel number in the token user interface. The secure channel number displayed in the user interface is 613122. The one-time password and the secure channel number, which will expire after a single use, are displayed upon the input of a correct PIN.

Referring back to FIG. 1, in one embodiment, the terminal 112 and the token 114 function together to form a user authentication mechanism. It can be a secure “user identification (ID) and one-time password” two-factor authentication system (e.g., a computer logon with a one-time password). Note that the user ID can be any unique identifier, for example, an electronic mail (e-mail) address, a telephone number, a member ID, an employee number, etc.

In the above configuration, the two factors refer to “what you know” and “what you have”. The first factor is “what you know,” which is the user's personal identification number (PIN). The second factor is “what you have,” which is the user's token 114. Examples of the token 114 include a personal computer, a mobile phone or smartphone, a personal digital assistant, or a standalone separate hardware token device. The token 114 provides a generated one-time password in response to being triggered by the application of the first factor, e.g., the PIN. The one-time password is then used for authenticating the first party 110 and consecutive one-time passwords for mutual authentication and secure channel establishment of the first party 110 and the second party 120 as is further described herein.

In one embodiment, the terminal 112 and the token 114 function together to form a secure channel establishment mechanism. The mechanism can use one or more session keys to establish the secure channel. The token 114 provides a generated one-time password subsequent to the one-time password sent to the second party 120. The mechanism can use the subsequently generated one-time password as a basis to compute the session keys. Given the second party 120 can generate the same session keys that are cryptographically related or equivalent to the session keys as is further described herein, the two parties can communicate using the secure channel without risk of interception or tampering.

The network 130 may be a wired or wireless network. Examples of the network 130 include the Internet, an intranet, a cellular network, or a combination thereof. It is noted that the terminal 112 and/or the token 114 of the first-party system 110 is structured to include a processor, memory, storage, network interfaces, and applicable operating system and other functional software (e.g., network drivers, communication protocols, etc.).

The second party 120 includes a web server 122, an application server 124, an authentication server 128, and a database server 126. The web server 122 communicatively couples the network 130 and the application server 124. The application server 124 communicatively couples the authentication server 128 and the database server 126. The authentication server 128 also communicatively couples the database server 126.

The web server 122 is a front end of the second-party 120 and functions as a communication gateway into the second-party 120. It is noted that the web server 122 is not limited to an Internet web server, but rather can be any communication gateway that appropriately interfaces the network 130, e.g., a corporation virtual private network front end, a cell phone system communication front end, or a point of sale communication front end. For ease of discussion, this front end will be referenced as a web server 122, although the principles disclosed are applicable to a broader array of communication gateways.

The application server 124 is configured to manage communications relating to user profiles and token identifiers between the first party 110 and the authentication server 128. The application server 124 is also configured to establish secure channels to the first party 110. The authentication server 128 is configured to encrypt and decrypt token secrets and parameters, generate one-time passwords, and verify received one-time passwords. The database server 126 is configured to store applications, data and other authentication related information from the application server 124 and the authentication server 128.

In one embodiment, security may be enhanced through a “principle of segregation of secrets”. In particular, the application server 124 has access to user profiles and token identifiers and the authentication server 128 has privileged access to the encrypted token secrets and parameters based on the given token identifiers by the application server 124. A token identifier of the first party 110 is an identification number or pointer to the actual token secrets and parameters for the corresponding user.

It is noted that the second-party system 120 can be configured on one or more conventional computing systems having a processor, memory, storage, network interfaces, peripherals, and applicable operating system and other functional software (e.g., network drivers, communication protocols, etc.). In addition, it is noted that the servers 122, 124, 126, and 128 are logically configured to function together and can be configured to reside on one physical system or across multiple physical systems.

In one embodiment, operation of the mutual authentication and secure channel establishment system 100 can be described as follows. The first party 110 uses its token 114 to compute a one-time password. The token 114 has access to token secrets and parameters and feeds (e.g., forwards or inputs) the information into a predefined one-time password cryptographic algorithm to compute the one-time password. In one embodiment, token secrets comprise cryptographic keys, random numbers, control vectors and other data (e.g., secrets) such as additional numerical values used as additional parameters for computation and cryptographic operations by the token 114 and by the authentication server 128. In addition, token parameters comprise control parameters, for example, encrypted PIN, a monotonically increasing or decreasing sequence number, optional transaction challenge code, transaction digests and usage statistics. In some embodiments, the token parameters may be dynamic such that they will be updated upon authentication operations.

Computation of the one-time password is usually done through a predefined one-time password cryptographic algorithm consisting of programmed computational steps and cryptographic operations. For example, the token 114 obtains the next value of a monotonically increasing or decreasing sequence number and feeds it together with the token secrets and other parameters into the predefined one-time password cryptographic algorithm to compute a one-time password. The sequence number is part of a unique set of token parameters that are loaded during token installation or synchronization.

Through the terminal 112, the first party 110 seeks to connect with the web server 122 of the second party 120 through the network 130 in order to submit a user ID and the computed one-time password. The web server 122 passes the user ID and the one-time password to the application server 124. The application server 124 searches for a token identifier corresponding to the user ID in the database server 128. A token identifier is a pointer to the actual token secrets and parameters that can be readily retrieved from the database server 128. Once the token identifier is located, the application server 124 forwards the one-time password it received along with the token identifier retrieved from the database server 126 to the authentication server 128.

The authentication server 128 retrieves the encrypted token secrets and parameters from the database server 126. In one embodiment, the encrypted token secrets and parameters are synchronized with the token secrets and parameters of the token 114. They are synchronized online through the network 130 during token creation and update and are synchronized cryptographically (e.g., mathematically without a network connection) after each successful authentication. The authentication server 128 then decrypts the token secrets and parameters and uses the information to verify the one-time password received from the first party 110.

Verification is usually done through the predefined one-time password cryptographic algorithm consisting of programmed computational steps and cryptographic operations. For example, a prediction index of the monotonically increasing or decreasing sequence number may be encoded inside a one-time password by the token 114. The authentication server 128 can decode the prediction index from the received one-time password submitted by the first-party 110. The algorithm used to encode/decode the prediction index can be a part of, or associated with the predefined one-time password cryptographic algorithm. Alternatively, the algorithm can be independent from the predefined one-time password cryptographic algorithm. The prediction index, which is a digest of the sequence number, will be used to estimate the value of the sequence number. The authentication server 128 then feeds the corresponding token secrets and parameters including the sequence number into the algorithm to compute a one-time password. Verification is successful if the computed one-time password and the received one-time password match. The use of prediction index helps to ensure that the first party 110 can be authenticated after unsuccessful attempts caused by human error (e.g., typographical error), network failure, or hacking, thus minimizing the token parameter out-of-sync problem found in prior arts.

Upon successful verification, the authentication server 128 obtains the next value of the sequence number (e.g., the next incremental or decremental value of the sequence number), and feeds the corresponding token secrets and parameters including the value of the sequence number into the predefined one-time password cryptographic algorithm to compute a consecutive one-time password. The application server 124 retrieves the consecutive one-time password from the authentication server 128, generates a symmetric session key (or a set of session keys for encryption, decryption, message signing and signature verification purposes) based on the computed consecutive one-time password, and uses the symmetric session key to establish a secure channel to the first party 110. For example, the application server 124 can use the consecutive one-time password as an input to derive the symmetric session key, and encrypt all communication to the first party 110 with the session key. Alternatively, the application server 124 can generate an encryption session key and a decryption session key, encrypt all communication to the first party 110 with the encryption session key, and decrypt all communication from the first party 110 with the decryption session key.

When the first party 110 receives messages from the second party 120 at its terminal 112, it authenticates the second party 120 by decrypting the messages. To do this, the first party 110 uses its token 114 to compute a consecutive one-time password. The first party 110 also generates a symmetric session key (or a set of session keys for encryption, decryption, message signing and signature verification purposes) based on the computed consecutive one-time password and decrypts the received messages with the symmetric session key. For example, the first party 110 can use the consecutive one-time password as an input to derive a symmetric session key, and decrypt the messages received from the second party 120 using the symmetric session key.

To generate the consecutive one-time password, the token 114 obtains the next value of the sequence number and feeds it along with the token secrets and the other token parameters into the predefined one-time password cryptographic algorithm.

In one embodiment, the two parties may verify the validity of the secure channel by encrypting known secrets and exchanging the encrypted known secrets. A secure channel is valid when the parties of the secure channel use proper encryption key(s) and decryptions key(s) when conducting communication through the secure channel. The validity of the secure channel is successfully verified if the decrypted messages match the known secrets. A known secret can be a static text (e.g., “authentication successful” notification message) or a dynamic text (e.g., the date and time when the party encrypted the message).

In another embodiment, a challenge-response mechanism is employed to authenticate the two parties and to verify the validity of the newly established secure channel. The first party encrypts a random challenge code with the session key and sends it to the second party. The second party decrypts the received encrypted challenge code with the session key, derives a response code from the random challenge code, encrypts the response code with the session key, and echoes back to the first party with the encrypted response code. The first party will then decrypt the received encrypted response code to verify the validity of the secure channel and to authenticate the second party. Similarly, the second party can perform a challenge-response to verify the validity of the secure channel and to authenticate the first party.

Upon successful verification of the authenticity of the two parties 110 and 120 and the validity of the secure channel, mutual authentication is achieved, and the first party 110 can commence trusted communication through the secure channel with the second party 120 via the terminal 112, the network 130, the web server 122, and the application server 124. That is, the two parties 110 and 120 can use the session keys generated during the authentication process to encrypt and decrypt messages send to and from each other. Alternatively, the two parties can use the session keys to establish the secure channel for a Virtual Private Network (VPN) connection or a HyperText Transfer Protocol Secure (HTTPS) connection. A VPN connection can be proprietary protocol based or Secure Socket Layer (SSL) based. Because the session keys are generated within the two parties, they are neither communicated in a network nor predefined. Thus, using these session keys to establish the secure channel would enhance the security of VPN, HTTPS, and other communication methods that require the use of a negotiated session key to establish a secure channel.

The configuration described includes a number of advantages. For example, the session key and the computed consecutive one-time password are never sent over the communication network between the first party 110 and the second party 120. Therefore, the identity of the first party 110 and the second party 120 are authenticated and both parties 110, 120 are assured that the other party is genuine and the secure channel established is immune of interception and tampering. Hence, the overall scheme provides a high level of security. Another advantage is robustness. The passwords used to authenticate both parties 110, 120 and to establish the secure channel are one-time passwords. Thus even if malicious parties could steal the passwords by eavesdropping on the parties' network connection or implanting keyboard monitoring spy-ware in the first party 110, those passwords could do no harm to the parties since they would expire after a single use.

Still another advantage is system flexibility and extensibility. First, both parties only need to share a single set of token secrets and parameters. The mutual authentication and the secure channel are established by sharing a single one-time password. Second, the system can use the most common user interface of “user ID and password” such that both parties 110, 120 have immediate familiarity with the authentication process.

### An Example of Mutual Authentication and Secure Channel Establishment Process

The principles described herein can be further illustrated through an example of a mutual authentication and secure channel establishment process. In this example, there is a user and a computing server. The user is functionally similar to the first party 110 and the computing server is functionally similar to the second party 120. The processes described with respect to these parties are performed on the respective terminal, computing system, and/or token as previously described. Communication between the user and the computing server is through a network functionally similar to the network 130.

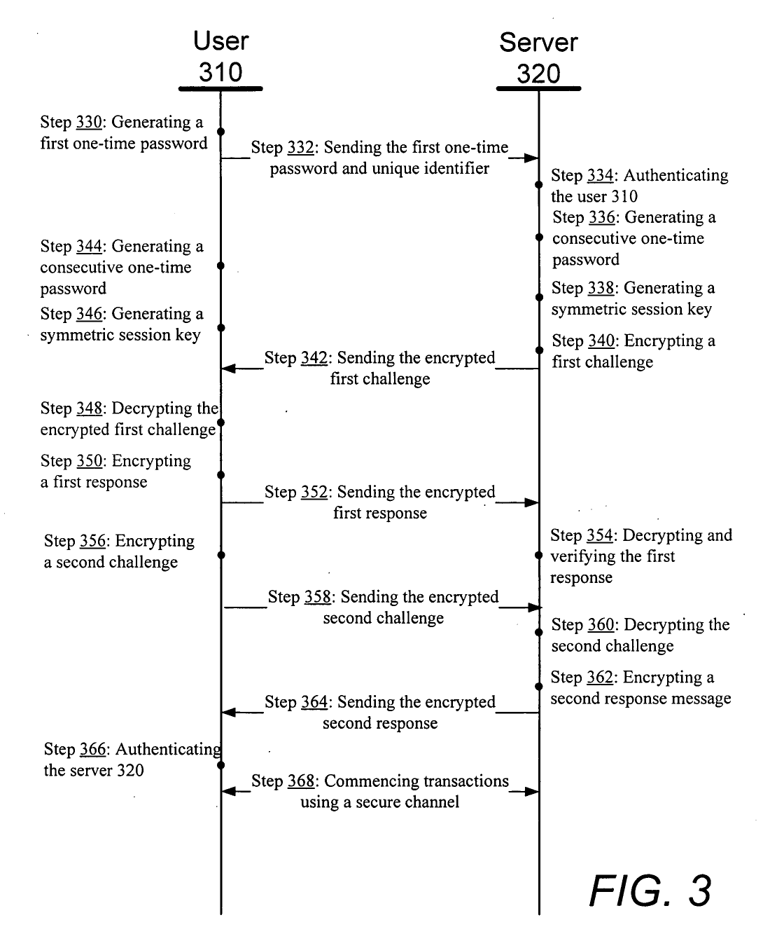

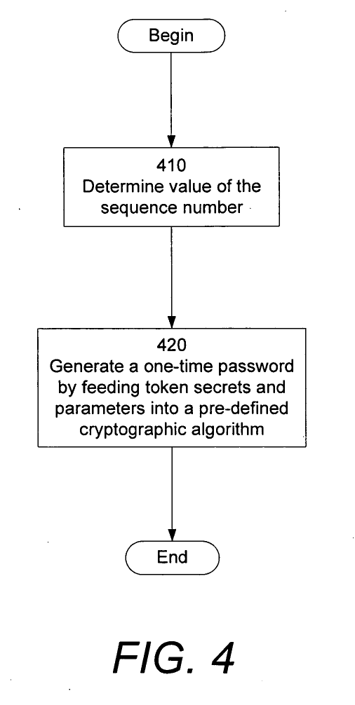

FIG. 3 illustrates one embodiment of a process for establishing mutual authentication and a secure channel between a user 310 and a server 320. The process starts with the user 310 generating 330 a one-time password to authenticate the identity of the user 310. One embodiment of the process of generating the one-time password is illustrated in FIG. 4. The process starts with the user 310 determining 410 the value of a sequence number. The sequence number is a monotonically increasing or decreasing number used as a token parameter in generating the one-time password.

In one embodiment, the next value of the sequence number is monotonically increasing or decreasing from the present value. The value of the sequence number of the user 310 are synchronized with the server 320 at the time of token creation and subsequently synchronized upon each successful verification by the server 320. A prediction index is calculated as a digest of the current sequence number and encoded into the current one-time password by the token of the user 310 such that the server 320 can decode and anticipate the correct sequence number for one-time password verification and sequence number synchronization. The user 310 determines 410 the next value of the sequence number and uses it to generate the most recent one-time password. In another embodiment, the user 310 ignores one or more next values, and uses the value after to generate the most recent one-time password.

After determining 410 the value of the sequence number, the user 310 generates 420 a one-time password by feeding token secrets and parameters including the value of the sequence number into a predefined one-time password cryptographic algorithm. The algorithm produces a hash (that transforms into the one-time password) from the token secrets and parameters. The hashing process of the algorithm is used because it is difficult to invert, and it is computationally infeasible to find different token secrets and parameters for the algorithm to compute to that same hash (i.e. the one-time password). Examples of conventional algorithms include MD5 and SHA-1.

For example, the token used by the user 310 to generate one-time passwords can be an application running on a mobile phone or a smart phone. The determination 410 and the generation 420 of one-time password can both be conducted by the application without user intervention. The user 310 only needs to request the application for one-time passwords.

Referring back to FIG. 3, the user 310 sends 332 to the server 320 the generated one-time password along with its unique identifier. In one embodiment, the generated one-time password expires as soon as the user 310 sends 332 it out, and the next time when the user 310 generates a one-time password, it will be a different one.

Continue with the above example, the user 310 can visit a website hosted by the server 320 to send 332 to the server 320 the generated one-time password along with its unique identifier. This can be done by the user 310 using a web browser (e.g., Internet Explorer, Mozilla Firefox, or the like) running on a terminal connected to the server 320.

The server 320 authenticates 334 the user 310 by decoding the prediction index from the received one-time password to calculate a value of the sequence number to generate a one-time password as illustrated in FIGS. 2 and 4 and discussed above and matching the generated one-time password with the received one-time password. The calculated value of the sequence number will be set no smaller than the next value of the sequence number used for the previously successful one-time password verification.

The one-time password is generated using a predefined one-time password cryptographic algorithm, which is functionally equivalent to the predefined one-time password cryptographic algorithm the user 310 used to generate 330 the one-time password sent 332 to the server 320. The server 320 generates the one-time password by passing the synchronized token secrets and parameters including the predicted value of the sequence number into the algorithm and checks if it matches with the received one-time password. Upon successful matching of the server 320 generated one-time password and the received one-time password from user 310, authentication 334 is successful and the sequence number is synchronized between the user 310 and the server 320.

Upon successfully authorization of 334 the user 310, the server 320 obtains the next value of the sequence number and generates 336 a one-time password (i.e. the “consecutive one-time password”), and generates 338 a session key (e.g., a symmetric session key) or a set of session keys (e.g., one encryption session key and one decryption session key) based on the consecutive one-time password. The server 320 generates 336 the one-time password by following the process illustrated in FIG. 4 and discussed above. In one embodiment, the value of the session key is cryptographically related to or derived from the value of the consecutive one-time password. In one embodiment, the generated one-time password expires as soon as the server 320 generates 338 the session key, and the next time when the server 320 generates a one-time password, it will be a different one.

The server 320 encrypts 340 a predefined message (the challenge) using the generated session key and sends 342 the encrypted message to the user 310. The predefined message can be a static text (e.g., “authentication successful” text message) or a dynamic text (e.g., the date and time when the second party encrypted the message).

The user 310 uses the token to determine the next value of the sequence number and generate 344 a one-time password subsequent to the one-time password sent 332 to the server 320, and generates 346 a session key based on the generated one-time password. The user 310 can generate 346 the session key after it sends 332 the one-time password to the server 320. Alternatively, the user 310 can generate 346 the session key after it receives the encrypted message from the server 320.

The user 310 decrypts 348 the encrypted challenge received from the server 320 and verifies the predetermined message. In one embodiment, upon successfully verifying the predetermined message, the user 310 and the server 320 are determined to have achieved mutual authentication and the secure channel is determined valid. The user 310 and the server 320 can commence 368 transactions through the secure channel. If decryption 348 fails because the encrypted message was not received, the server 320 may be a malicious party hosting a phishing scam.

In another embodiment, a challenge-response mechanism is employed to authenticate the second party and to verify the validity of the newly established secure channel. In this embodiment, the server 320 can generate a random challenge code (the challenge), encrypts 340 it and sends 342 to the user 310. After the user 310 decrypts 348 the received encrypted challenge code with the session key, it derives a response code from the random challenge code using a formula shared by the server 320, encrypts 350 the response code with the session key, and sends 352 the encrypted response code to the server 320.

The server 320 uses the session key to decrypt 354 the encrypted response code received from the user 310 and verifies that the response code is properly derived from the random challenge code sent 342 to the user 310. For example, the server 320 can derive a response code from the random challenge code using the shared formula and compare the derived response code and the decrypted response code. Upon successful verification, the server 320 determines that the secure channel is valid.

The user 310 can similarly perform a challenge-response to verify the validity of the secure channel and to authenticate the server 320. The user 310 encrypts 356 a randomly generated challenge code with the session key and sends 358 the encrypted challenge code to the server 320. The server 320 decrypts 360 the encrypted challenge code received from the user 310, derives a response code from the decrypted challenge code using the shared formula, encrypts 362 the response code with the session key, and sends 364 the encrypted response code to the user 310.

The user 310 uses the session key to decrypt the encrypted response code received from the server 320. The user 310 verifies that the response code is properly derived from the random challenge code sent 358 to the server 320. Upon successful verification, the user 310 determines that the secure channel is valid and authenticates 366 the server 320. If the authentication 366 fails either because the decryption fails or the verification of the received response code, the server 320 may be a malicious party hosting a phishing scam.

In one embodiment, after the user 310 sends 332 the one-time password to the web server, the web server can automatically embed an applet that runs within the web browser. Alternatively, the user 310 may pre-install the applet in the terminal 112. The applet can prompt the user 310 to provide the one-time password subsequent to the one that was sent 332 to the server 320 (hereinafter called “the consecutive one-time password”). The consecutive one-time password is computed by the token of the user 310 and displayed onto the token for the user 310 to submit to the applet. An example of the token user interface is described above with reference to FIG. 2. After the user 310 uses the token to generate the consecutive one-time password and inputs to the applet, the applet computes the session key based on the value of the consecutive one-time password. After the applet receives the encrypted challenge from the server 320, it decrypts 348 the challenge using the computed session key, encrypts 350 a derivation of the decrypted challenge (the response) with the session key, and sends 352 it to the server 320 to verify. This process is a challenge-response protocol and the challenge-response can repeat for the other direction from the server 320 to the user 310, as discussed above. Upon successful exchange of the challenge-response protocol, the secure channel is established and validated. Communication and transactions 368 can then take place. That is, the user 310 and the server 320 can use the session keys to encrypt and decrypt messages sent to and from each other. In one embodiment, the established secure channel expires after a period of time. Alternatively, the user 310 and the server 320 can periodically generate new session keys to re-establish the secure channel with other encryption/decryption keys.

The disclosed embodiments have many practical applications. For example, the process described above can be utilized to ensure that the parties of an Internet phone conversation (or video conference) are genuine and the conversation and images are not intercepted. Alternatively, the process can be implemented in transfers of electronic content (e.g., online music, video, and software delivery) to authenticate the identity of the content provider and the recipient and to guarantee the integrity of the electronic content.

Upon reading this disclosure, those of skill in the art will appreciate still additional alternative structural and functional designs for a system and a process for mutual authentication and secure channel establishment for secured electronic communication between parties through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for electronic communication, the method comprising:
receiving a unique identifier associated with a user and a first one-time password, the first one-time password being generated using a first cryptographic algorithm;
authenticating the user based on the unique identifier and the first one-time password;
generating, in response to the user being authenticated, a second one-time password using a second cryptographic algorithm, the second cryptographic algorithm being associated with the first cryptographic algorithm; and
establishing, in response to the user being authenticated, a secure channel using a session key created at least in part from the second one-time password.

2. The method of claim 1, wherein the first and second cryptographic algorithms are either one-way hashing algorithms or one-way encryption algorithms.

3. The method of claim 1, further comprising:
identifying the second cryptographic algorithm based on the unique identifier, wherein authenticating the user comprises authenticating the user based on the second cryptographic algorithm and the first one-time password.

4. The method of claim 1, wherein the first and second cryptographic algorithms are functionally equivalent and have the same token secrets, the first and second cryptographic algorithms having a sequence parameter, the value of the sequence parameter being in a predeterminable sequence of values.

5. The method of claim 4, wherein authenticating the user comprises:
generating a third one-time password using the second cryptographic algorithm, the value of the sequence parameter used to generate the third one-time password being determined by an index and the predeterminable sequence, the index being determined by applying an index algorithm to the first one-time password, the index algorithm being associated with the second cryptographic algorithm; and
responsive to the first one-time password being the same as the third one-time password, determining that the user is authenticated, otherwise determining that the user is not authenticated.

6. The method of claim 4, wherein authenticating the user comprises:
generating a third one-time password using the second cryptographic algorithm, the value of the sequence parameter used to generate the third one-time password being the successor in the predeterminable sequence of the value of the sequence parameter used to generate a previous one-time password; and
responsive to the first one-time password being the same as the third one-time password, determining that the user is authenticated, otherwise determining that the user is not authenticated.

7. The method of claim 6, wherein the previous one-time password is a one-time password generated during the most recent successful authentication with the user.

8. A method for electronic communication, the method comprising:
generating a first one-time password using a first cryptographic algorithm;
transmitting the first one-time password and a unique identifier associated with a user to a server;
generating a second one-time password using the first cryptographic algorithm;
establishing a secure channel with the server using a first session key created at least in part from the second one-time password, wherein the server creates a second session key using a second cryptographic algorithm, the second cryptographic algorithm being associated with the first cryptographic algorithm; and
authenticating the server based on the establishment of the secure channel.

9. The method of claim 8, wherein the first and second cryptographic algorithms are either one-way hashing algorithms or one-way encryption algorithms.

10. The method of claim 8, wherein the first and second cryptographic algorithms are functionally equivalent and have the same token secrets, the first and second cryptographic algorithms having a sequence parameter, the value of the sequence parameter being in a predeterminable sequence of values.

11. The method of claim 10, wherein generating the first one-time password comprises:
generating the first one-time password using the first cryptographic algorithm, the value of the sequence parameter used to generate the first one-time password being successive in the predeterminable sequence of the value of the sequence parameter used to generate a previous one-time password, the value of the sequence parameter used to generate the first one-time password being represented by an index of the predeterminable sequence, the index being encoded into the one-time password.

12. The method of claim 10, wherein generating the first one-time password comprises:
generating the first one-time password using the first cryptographic algorithm, the value of the sequence parameter used to generate the first one-time password being the successor in the predeterminable sequence of the value of the sequence parameter used to generate a previous one-time password.

13. The method of claim 12, wherein the previous one-time password is the most recently generated one-time password.

14. The method of claim 10, wherein generating the second one-time password comprises:
generating the second one-time password using the first cryptographic algorithm, the value of the sequence parameter used to generate the second one-time password being the successor in the predeterminable sequence of the value of the sequence parameter used to generate the first one-time password.

15. An electronic communication apparatus comprising:
a processor and
a memory structured to store instructions executable by the processor, the instructions corresponding to:
receiving a unique identifier associated with a user and a first one-time password, the first one-time password being generated using a first cryptographic algorithm;
authenticating the user based on the unique identifier and the first one-time password;
generating, in response to the user being authenticated, a second one-time password using a second cryptographic algorithm, the second cryptographic algorithm being associated with the first cryptographic algorithm; and
establishing, in response to the user being authenticated, a secure channel using a session key created at least in part from the second one-time password.

16. An electronic communication apparatus comprising:
a processor and
a memory structured to store instructions executable by the processor, the instructions corresponding to:
generating a first one-time password using a first cryptographic algorithm;
transmitting the first one-time password and a unique identifier associated with a user to a server;
generating a second one-time password using the first cryptographic algorithm;
establishing a secure channel with the server using a first session key created at least in part from the second one-time password, wherein the server creates a second session key using a second cryptographic algorithm, the second cryptographic algorithm being associated with the first cryptographic algorithm; and
authenticating the server based on the establishment of the secure channel.

17. A computer program product for use in conjunction with a computer system, the computer program product comprising a computer readable storage medium and a computer program mechanism embedded therein, the computer program mechanism including:
instructions for receiving a unique identifier associated with a user and a first one-time password, the first one-time password being generated using a first cryptographic algorithm;
instructions for authenticating the user based on the unique identifier and the first one-time password;
instructions for generating, in response to the user being authenticated, a second one-time password using a second cryptographic algorithm, the second cryptographic algorithm being associated with the first cryptographic algorithm; and
instructions for establishing, in response to the user being authenticated, a secure channel using a session key created at least in part from the second one-time password.

18. A computer program product for use in conjunction with a computer system, the computer program product comprising a computer readable storage medium and a computer program mechanism embedded therein, the computer program mechanism including:
instructions for generating a first one-time password using a first cryptographic algorithm;
instructions for transmitting the first one-time password and a unique identifier associated with a user to a server;
instructions for generating a second one-time password using the first cryptographic algorithm;
instructions for establishing a secure channel with the server using a first session key created at least in part from the second one-time password, wherein the server creates a second session key using a second cryptographic algorithm, the second cryptographic algorithm being associated with the first cryptographic algorithm; and
instructions for authenticating the server based on the establishment of the secure channel.
